(19) United States
(12) Patent Application Publication
(10) Pub. No.: US 2019/0272483 A1
(43) Pub. Date: Sep. 5, 2019

(54) METHOD AND SYSTEM FOR ALLOCATING VEHICLES TO PASSENGERS

(71) Applicant: ANI TECHNOLOGIES PRIVATE LIMITED, Bengaluru (IN)

(72) Inventors: Nilesh Hiray, Nashik (IN); Pranav Tiwari, Bangalore (IN); Hansraj Choudhary, Bangalore (IN); Utsab Saha, New Delhi (IN); Surat Singh Bhati, Bangalore (IN); Manish Singh, Bangalore (IN); G Vaishnavi Devi, Bangalore (IN)

(73) Assignee: ANI TECHNOLOGIES PRIVATE LIMITED

(21) Appl. No.: 16/287,337

(22) Filed: Feb. 27, 2019

(30) Foreign Application Priority Data
Mar. 1, 2018 (IN) 201841007694

(51) Int. Cl. G06Q 10/02; G06Q 50/30

(52) U.S. Cl. CPC G06Q 10/02; H04L 63/0838; G06Q 50/30

(57) ABSTRACT

A method and a system for allocating a vehicle to a passenger is provided. A booking request for booking a ride is received from a passenger device of the passenger. Based on the booking request, a first message is transmitted to the passenger device that indicates a confirmation of the booking request without allocating any vehicle to the passenger. The first message includes a code for pairing with one of vehicles in a queue at a pickup area. The passenger provides the code to a driver of a first vehicle from the vehicles in the queue, when the passenger is at the pickup area. The code is received from a driver device of the first vehicle. The code is validated, and the first vehicle is allocated to the passenger for the ride based on successful validation of the code.

### CROSS-RELATED APPLICATIONS

This application claims priority of Indian Application Serial No. 201841007694, filed Mar. 1, 2018, the contents of which are incorporated herein by reference.

### FIELD OF THE INVENTION

The present invention relates generally to vehicle allocation systems, and more particularly, to a method and a system for allocating vehicles to passengers in a vehicle transit system.

### BACKGROUND

Passengers avail various public and private transportation services for making trips to and from work places or for personal commute and travel. In modern cities, vehicle service providers, such as cab service providers, play an important role by providing the on-demand vehicle services to the passengers to travel between source and destination locations.

Generally, the demands for the various public and private transportation services are on a higher side in some specific areas, such as airports, railway stations, or bus stations. Conventionally, to cater the excess demands from the passengers at the airports, the railway stations, or the bus stations, the vehicle service providers provide vehicle services to the passengers. The vehicle services are accessible through pre-paid vehicle booths that are located in the vicinity of the airports, the railway stations, or the bus stations. Typically, a pre-paid vehicle booth is managed manually, where a passenger pays in advance to avail a vehicle service of a vehicle from available vehicles in a queue. After making the advance payment (either partially or in total), the vehicle is allocated to the passenger by issuing a token that includes a name of the passenger, a destination address, advanced payment details, an amount due to be paid, a number of bags, a vehicle number, driver details, or the like. Further, as the pre-paid vehicle booth is managed in an offline manner, a driver of the vehicle allocated to the passenger may demand an extra amount for providing the vehicle services, for example, in an event of late night services. Such instances are difficult to monitor in the offline management of the vehicle services, which may cause inconvenience to the passenger.

One solution to the aforementioned problem is to obtain the feedback from the passenger with respect to the completed ride through a software application or by providing details of a website of the pre-paid vehicle booth where the passenger may lodge a complaint. However, many times due to the offline management of the vehicle services, the vehicle number of the vehicle allocated to the passenger and the driver details are not mentioned in the issued token. Thus, lodging the complaint against the driver of the allocated vehicle may not provide any possible solution to the passenger. Further, if the issued token is stolen or lost, the token may be misused by other individual as the pre-paid vehicle booth does not rely on validation of the passenger.

Recently, vehicle allocation has seen a tremendous improvement. Now-a-days, the vehicle service provider provides an on-line platform to initiate a request for a ride. The on-line platform offers various services where the passenger is able to select a type of vehicle, a type of service, or the like. For instance, the passenger sends a booking request for the ride by means of the on-line platform, and provides other preferential information such as a pickup location, a drop-off location, a time of the ride, a type of the vehicle, or the like. Based on the booking request, the vehicle service provider allocates the vehicle to the passenger for the ride. However, even though the vehicle services are managed in an online manner, there are few challenges associated with the vehicle allocation. Firstly, based on the booking request provided by the passenger, availability of the vehicles is checked in the vicinity of the pickup location. Further, the other preferential information is matched with the available vehicles, and the booking request is sent to the matched vehicles. The on-line platform waits for an acceptance of the booking request by drivers of the matched vehicles. During all these events, the passenger keeps waiting for allocation, and it may be possible that no vehicle is allocated to the passenger. In such a scenario, the online platform of the vehicle service provider fails to provide the vehicle services to the passenger.

Further, in a scenario where the booking request is accepted, the passenger has to wait for the allocated vehicle to arrive at the pickup location. In another scenario where the allocated vehicle is at the pickup location but the passenger has not reached the pickup location, the driver of the allocated vehicle ends up waiting for the passenger. One possible solution to the aforementioned problem is to provide an estimated time of arrival (ETA) of the passenger and the driver to the driver and the passenger, respectively. However, the problem still exists since the ETA may not be accurately estimated due to traffic congestions, unplanned events, road accidents, or the like.

In light of the foregoing, there exists a need for a method and a system that solves the above-mentioned problems and allocates vehicles efficiently to the passengers. Further, the method and the system should minimize the waiting times of the driver and the passenger at the pickup location after the vehicle has been allocated to the passenger.

### SUMMARY

Various embodiments of the present invention provide a method and a system for allocating vehicles to passengers. The method includes one or more operations that are executed by circuitry of the system to receive a booking request for booking a ride from a passenger device of a passenger over a communication network. In response to the received booking request, the circuitry transmits a first message to the passenger device over the communication network. The first message indicates a confirmation of the booking request without allocating any vehicle to the passenger. The confirmation message may indicate an availability of one or more vehicles at or near a pickup area. The first message includes a code for pairing with one of the one or more vehicles in a queue at the pickup area. The code may be at least one of a one-time-password (OTP) code, a quick-response (QR) code, or inherence information of the passenger. The circuitry transmits a second message to the passenger device over the communication network, when the booking request has been confirmed. The second message is transmitted for directing the passenger to the pickup area from a current location of the passenger. Based on the second message, the passenger may arrive at the pickup area. When the passenger is at the pickup area, the passenger provides the code to a driver of a first vehicle from the one or more vehicles at the pickup area. In another embodiment, the passenger device transmits the code to a driver device of the driver of the first vehicle over the communication network.

The circuitry receives the code from the driver device of the first vehicle and validates the received code. Based on successful validation of the code, the circuitry transmits a third message to the driver device over the communication network. The third message indicates successful validation of the code, and the first vehicle associated with the driver device that has transmitted the code is allocated to the passenger. The circuitry transmits a fourth message to the driver device of the first vehicle, which includes at least destination information associated with the booking request.

Before or after the passenger has reached the pickup area, the circuitry further transmits a fifth message to the passenger device indicating a cancellation of the booking request when the vehicles are not present at the pickup area or a parking area. The booking request may be cancelled based on at least one of a last-in-first-out (LIFO), a passenger value, a booking value, or a distance between the passenger and the pickup area.

The circuitry further controls an availability of the one or more vehicles in the queue at the pickup area based on a sequence of arrival of the one or more vehicles in a zone. On detecting an incoming vehicle in the zone, the circuitry transmits a sixth message to the driver device of the incoming vehicle for directing the incoming vehicle to the pickup area of the zone in an event of an available space in the queue at the pickup area and in the absence of the one or more vehicles in the parking area of the zone. In another embodiment, the circuitry transmits a seventh message to the driver device of the incoming vehicle for directing the incoming vehicle to the parking area when the space is not available in the queue at the pickup area.

After detecting the available space in the queue at the pickup area, the circuitry transmits an eighth message to the driver device of a second vehicle from the one or more vehicles in the parking area for directing the second vehicle from the parking area to the pickup area. The eighth message is transmitted to the driver device of the second vehicle based on at least one of the sequence of arrival of the one or more vehicles in the zone, the available space in the queue at the pickup area, a driver rating of each driver associated with the one or more vehicles in the parking area, or a vehicle type associated with each vehicle in the parking area.

Thus, the method and the system of the present invention effectively allocate the first vehicle to the passenger such that the waiting time of the driver or the passenger at the pickup area is minimized. The method and the system of the present invention control and manage the movement of the one or more vehicles in the parking area or the pickup area of the zone. The method and the system of the present invention further control and manage the movement of the one or more vehicles from the parking area to the pickup area based on the available space in the queue at the pickup area.

### BRIEF DESCRIPTION OF THE DRAWINGS

The accompanying drawings illustrate the various embodiments of systems, methods, and other aspects of the invention. It will be apparent to a person skilled in the art that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa.

FIG. 1 is a block diagram that illustrates an environment in which various embodiments of the present invention are practiced;

FIG. 2 is a timing diagram that illustrates communication of messages between a server, a passenger device, and a driver device of FIG. 1, in accordance with an embodiment of the present invention;

FIG. 3A is a block diagram that illustrates an exemplary environment for allocating vehicles to passengers, in accordance with an embodiment of the present invention;

FIGS. 3B-3D are block diagrams that illustrate exemplary environments for controlling and managing movement of vehicles in a zone, in accordance with an embodiment of the present invention;

FIG. 4 is a flow chart that illustrates a method for allocating vehicles to passengers, in accordance with an embodiment of the present invention;

FIG. 5 is a flow chart that illustrates a method for controlling and managing an availability of vehicles in a queue at a pickup area, in accordance with an embodiment of the present invention;

FIG. 6 is a flow chart that illustrates a method for controlling and managing movement of an incoming vehicle in a zone, in accordance with an embodiment of the present invention; and

FIG. 7 is a block diagram that illustrates a computer system for allocating vehicles to passengers, and controlling and managing movement of the vehicles in a zone, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of system components, which constitutes systems and methods for allocating vehicles to passengers. Accordingly, the components and the method steps have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

A vehicle is a means of transport that is deployed by a vehicle transit system, such as a vehicle service provider, to provide vehicle services to passengers. For example, the vehicle is an automobile, a bus, a car, a bike, a truck, or the like. A passenger may travel in the vehicle to commute between pickup and destination locations. Hereinafter, various methods of providing the vehicle services to the passengers by the vehicle transit system have been described that will become apparent to a person having ordinary skill in the relevant art.

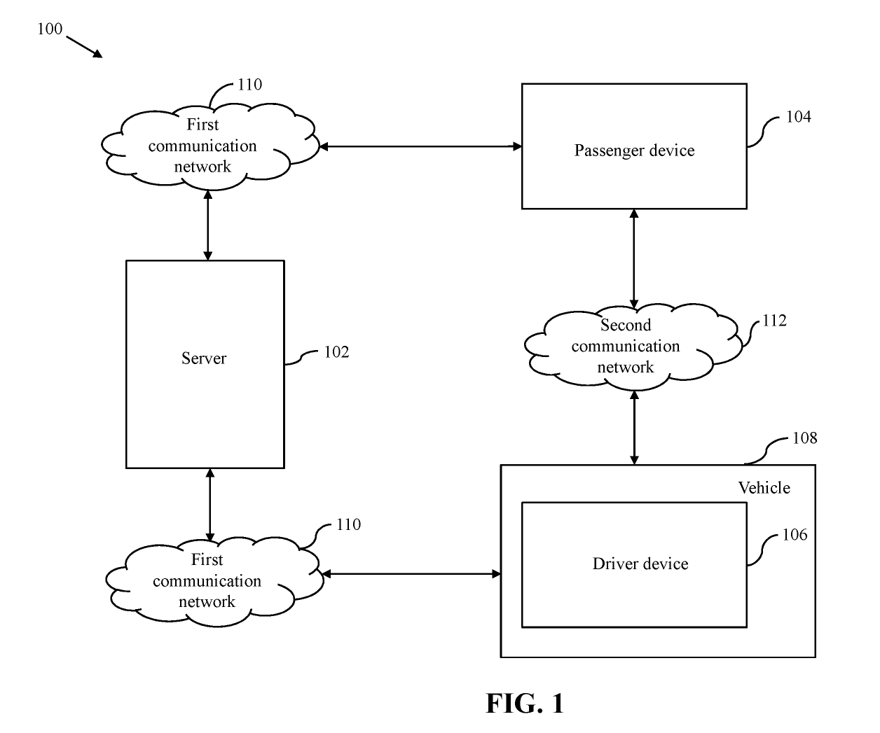

FIG. 1 is a block diagram that illustrates an environment 100 in which various embodiments of the present invention are practiced. The environment 100 includes a server 102, a passenger device 104, and a driver device 106 associated with a vehicle 108. The passenger device 104 and the driver device 106 communicate with the server 102 by way of a first communication network 110. Examples of the first communication network 110 include, but are not limited to, a wireless fidelity (Wi-Fi) network, a light fidelity (Li-Fi) network, a satellite network, the Internet, a mobile network such as a cellular data network, a high speed packet access (HSPA) network, or any combination thereof. The passenger device 104 and the driver device 106 communicate with each other by way of a second communication network 112. Examples of the second communication network 112 include, but are not limited to, a Wi-Fi network, a Li-Fi network, a satellite network, the Internet, a short range communication protocol such as a Bluetooth, an Infrared, or a short messaging service, a mobile network such as a cellular data network, a HSPA network, or any combination thereof. In an exemplary embodiment, the environment 100 may include a single communication network, such as the first or second communication network 110 or 112. In such a scenario, the server 102, the passenger device 104, and the driver device 106 may communicate with each other by way of the first or second communication network 110 or 112.

The server 102 is a computing device, a software framework, or a combination thereof, that may provide a generalized approach to create the application server implementation. In an embodiment, the operation of the server 102 may be dedicated to execution of procedures, such as, but not limited to, programs, routines, or scripts stored in one or more memories for supporting its applied applications. In an embodiment, the server 102 processes a booking request for booking a ride received from the passenger device 104 of a passenger. Based on the processed booking request, the server 102 determines a destination location and other ride-related details (for example, a vehicle type, a time of the requested ride, a number of passengers, or the like) that have been requested by the passenger for the ride. The server 102 determines an availability of one or more first vehicles (hereinafter, first vehicles) in a queue at a pickup area of a zone (e.g., an airport). The server 102 further determines an availability of one or more second vehicles (hereinafter, second vehicles) in a parking area of the zone. Based on the determined availability of the first or second vehicles, the server 102 transmits a first message to the passenger device 104 over the first communication network 110. The first message is transmitted without allocating any vehicle to the passenger. The first message indicates a confirmation of the received booking request, and includes a code for pairing with one of the first vehicles in the queue at the pickup area. The code may be a one-time-password (OTP) code or a quick-response (QR) code. The code may further be based on inherence information of the passenger. The inherence information includes biometric information of the passenger, such as fingerprints, voice patterns, facial patterns, eye retinas and irises, or any combination thereof.

Further, in an embodiment, the server 102 transmits a second message to the passenger device 104 over the first communication network 110 based on the confirmation of the booking request. The second message is transmitted for directing the passenger to the pickup area from a current location of the passenger. In an exemplary embodiment, the second message may be presented by means of a graphical representation, for example, by using a map application running on the passenger device 104 that directs the passenger to the pickup area from the current location. In another exemplary embodiment, the second message may be presented by means of a voice-based instruction that directs the passenger to the pickup area from the current location.

Further, in an embodiment, the server 102 receives the code from the driver device 106 of the vehicle 108. Herein, the vehicle 108 is a first vehicle from the first vehicles in the queue at the pickup area. In an exemplary embodiment, a driver of the first vehicle may have obtained the code from the passenger at the pickup area, and thereafter, may have inputted the code by means of a service application installed on the driver device 106 to transmit the code to the server 102. In another exemplary embodiment, the passenger device 104 may transmit the code to the driver device 106 of the first vehicle over the second communication network 112, and the driver device 106 further transmits the code to the server 102 over the first communication network 110.

After receiving the code from the driver device 106 of the first vehicle, the server 102 validates the received code. The received code may be validated to identify an authenticity of the received code i.e., whether the received code has been generated by the server 102 or not. The received code may further be validated to identify the authenticity of the passenger of the passenger device 104 to which the server 102 has transmitted the code in response to the booking request by the passenger. After successful validation of the code, the server 102 allocates the first vehicle associated with the driver device 106 to the passenger. The server 102 transmits a third message to the driver device 106 indicating successful validation of the code and allocation of the first vehicle to the passenger. The server 102 further transmits a fourth message to the driver device 106 over the first communication network 110 that includes at least the destination location associated with the booking request provided by the passenger. Further, the server 102 may transmit a fifth message to the passenger device 104 indicating successful validation of the code and allocation of the first vehicle for the ride.

In an embodiment, the server 102 controls and manages the availability of the first vehicles in the queue at the pickup area and the second vehicles in the parking area of the zone. The availability of the first vehicles in the queue at the pickup area is controlled based on a sequence of arrival of incoming vehicles in the zone that may be available for new rides associated with new booking requests to be allocated by the server 102. In an embodiment, in an event of an available space in the queue at the pickup area and in the presence of the second vehicles in the parking area, the server 102 transmits a sixth message to the driver device 106 of one of the second vehicles in the parking area for directing one of the second vehicles from the parking area to the pickup area. The sixth message may be transmitted based on at least one of the sequence of arrival of the second vehicles in the zone, the available space in the queue at the pickup area, a driver rating of the driver associated with each second vehicle in the parking area, or a vehicle type associated with each second vehicle in the parking area.

Further, when the space is available in the queue at the pickup area and the second vehicles are present in the parking area, the server 102 transmits a seventh message to the driver device 106 of an incoming vehicle (that may be available for a new booking request) in the zone. The seventh message is transmitted to the driver device 106 of the incoming vehicle for directing the incoming vehicle to the parking area. Further, when the space is available in the queue at the pickup area, the server 102 transmits an eighth message to the driver device 106 of the incoming vehicle for directing the incoming vehicle to the parking area. In another embodiment, when the space is available in the queue at the pickup area and the second vehicles are not present in the parking area, the server 102 transmits a ninth message to the driver device 106 of the incoming vehicle in the zone for directing the incoming vehicle to the queue at the pickup area. In another embodiment, when the space is available in the queue at the pickup area, the second vehicles are not present in the parking area, and the incoming vehicles are not detected in the zone, the server 102 checks for other vehicles that are currently operating with their destination locations in the zone.

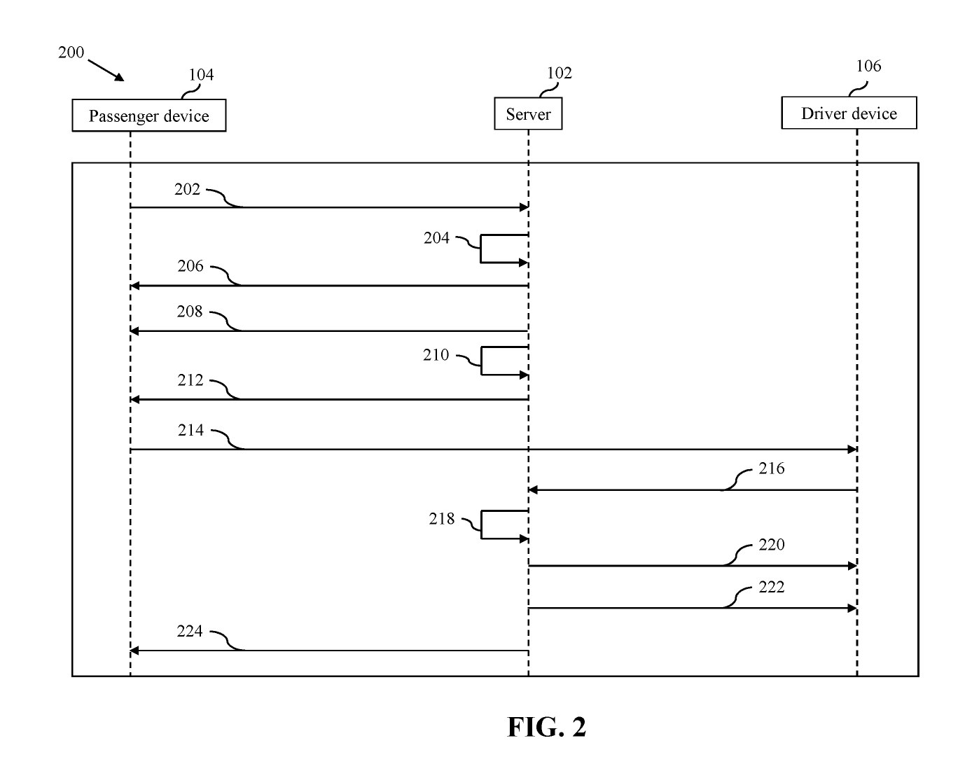

Further, in an embodiment, when at least the first, second, or incoming vehicles are not available in the zone and no other vehicles are detected with their destination locations in the zone, the server 102 may transmit a tenth message to the passenger device 104 indicating an unavailability of a vehicle or a cancellation of the booking request. The booking request may further be cancelled based on at least one of a last-in-first-out (LIFO), a passenger value, a booking value, or a distance between the current location of the passenger and the pickup area. Various operations of the server 102 have been described in detail in conjunction with FIGS. 2, 3A-3D, and 4-7. The server 102 may be realized through various web-based technologies such as a Java web-framework, a .NET framework, a PHP framework, or any other web-application framework. Examples of the server 102 include, but are not limited to, a personal computer, a laptop, or a network of computer systems.

The passenger device 104 is a computing device that is used by the passenger to perform one or more activities. For example, the passenger uses the passenger device 104 to schedule the ride between the source and destination locations. To schedule the ride, the passenger uses the passenger device 104 to initiate the booking request for the ride by means of a service application installed on the passenger device 104. The booking request may include ride-related information, for example, the source and destination locations or other service-related details and preferences of the passenger. The various modes of input used by the passenger may include, but are not limited to, a touch-based input, a text-based input, a voice-based input, a gesture-based input, or a combination thereof. Further, based on a confirmation of the ride request provided by the passenger, the passenger device 104 transmits the booking request to the server 102 over the first communication network 110. Further, the passenger uses the passenger device 104 to transmit the code to the driver device 106.

The passenger further uses the passenger device 104 to view the first, second, fifth, or tenth message transmitted by the server 102 in response to the booking request. Based on the first message, the passenger identifies that the booking request has been confirmed by the server 102. The first message includes the code for pairing with one of the first vehicles in the queue at the pickup area. Further, the passenger follows instructions (such as graphical representation-based instructions, map-based instructions, voice-based instructions, or text-based instructions) associated with the second message to reach the pickup area from the current location. Further, based on the fifth message, the passenger views successful validation of the code and allocation information of the first vehicle for the ride provided by the server 102. Further, in the event of cancellation of the booking request, the passenger views the tenth message to identify that the booking request has been canceled by the server 102. Examples of the passenger device 104 include, but are not limited to, a personal computer, a laptop, a smartphone, a tablet computer, and a personal digital assistant (PDA).

The driver device 106 is a computing device that is used by the driver to perform one or more activities. In an exemplary embodiment, the driver of the first vehicle in the queue at the pickup area uses the driver device 106 of the first vehicle to input the code provided by the passenger. In another example, the driver device 106 may receive the code from the passenger device 104 over the second communication network 112. The driver device 106 transmits the code to the server 102 over the first communication network 110. The driver of the first vehicle further uses the driver device 106 to view the third or fourth messages provided by the server 102 in response to the transmitted code. Based on the third message, the driver determines that the code has been successfully validated, and the first vehicle has been allocated to the passenger. Further, the driver of the first vehicle uses the driver device 106 to view the destination location of the allocated booking request based on the fourth message provided by the server 102. The driver further uses the driver device 106 to view a route between the source and destination locations of the booking request.

In another exemplary embodiment, the driver of a second vehicle from the second vehicles in the parking area uses the driver device 106 of the second vehicle to view the sixth message provided by the server 102. Based on the sixth message, the driver drives the second vehicle from the parking area to the queue at the pickup area. In yet another exemplary embodiment, the driver of the incoming vehicle uses the driver device 106 of the incoming vehicle to view the seventh, eighth, or ninth message provided by the server 102. Based on the seventh or eighth message, the driver of the incoming vehicle is directed towards the parking area i.e., the driver is instructed to drive the incoming vehicle to the parking area. Based on the ninth message, the driver of the incoming vehicle is directed towards the pickup area i.e., the driver is instructed to drive the incoming vehicle to the queue at the parking area.

In an exemplary embodiment, the driver device 106 may be a vehicle head unit. In another exemplary embodiment, the driver device 106 may be an external communication device, such as a smartphone, a PDA, a tablet computer, a laptop, or any other portable communication device, that is placed inside the vehicle 108 (such as the incoming, first, or second vehicle).

Referring now to FIG. 2, a timing diagram 200 that illustrates communication of messages between the server 102, the passenger device 104, and the driver device 106 of FIG. 1 is shown, in accordance with an embodiment of the present invention. The passenger uses the passenger device 104 for scheduling the ride between the source and destination locations, when the passenger is in the zone. The zone is a geographical area associated with an airport, a railway station, a bus station, or the like. To schedule the ride, the passenger device 104 renders a graphical user interface (not shown) to the passenger by means of the installed application based on an input provided by the passenger. At 202, the passenger device 104 transmits the booking request provided by the passenger to the server 102 over the first communication network 110. The booking request includes the ride-related information, such as the source location, the destination location, a waiting time, a vehicle type, a preference of the passenger, or other service-related details.

Based on the received booking request, at 204, the server 102 checks for the availability of the first or second vehicles in the zone. In an embodiment, the server 102 checks for the availability of the first or second vehicles based on Global Positioning System (GPS) information and a current booking status of the first or second vehicles. The GPS information may be obtained from GPS-enabled devices (not shown) including position-tracking sensors that are embedded in the driver device 106 associated with the first or second vehicles. At 206, when the first vehicles are available in the queue at the pickup area of the zone, the server 102 transmits the first message to the passenger device 104 indicating the confirmation of the booking for the ride requested by the passenger without allocating any vehicle to the passenger for the ride. The first message may be a pop-up message, an alert message, a short message service (SMS), or the like. In an embodiment, the first message further includes the code that can be used for pairing with one of the first vehicles in the queue at the pickup area. In another embodiment, the code may be received in a separate message after receiving the first message. The code is one of the OTP code or the QR code. The code may further be based on the inherence information, for example, the fingerprints, the facial patterns, the voice patterns, or the eye retinas, or irises of the passenger.

In another embodiment, when the first vehicles are not available in the queue at the pickup area, the server 102 checks for the availability of the second vehicles in the parking area of the zone. If the second vehicles are available in the parking area, the server 102 transmits the first message to the passenger device 104 and the sixth message to the driver device 106 of the second vehicle in the parking area. The sixth message is transmitted for instructing the driver of the second vehicle for directing the second vehicle from the parking area to the pickup area of the zone. The server 102 may select the second vehicle from the second vehicles based on the sequence of arrival of the second vehicle in the zone, the available space in the queue at the pickup area, the driver rating of the driver of the second vehicle, the vehicle type associated with the second vehicle, or any combination thereof.

In another embodiment, when the incoming vehicle (that may be available for the new booking request) is detected in the zone, the server 102 checks for the available space in the queue at the pickup area and the presence of the second vehicles in the parking area. If the queue at the pickup area has the available space and the parking area includes the second vehicles, the server 102 transmits the seventh message to the driver device 106 of the incoming vehicle in the zone. The seventh message instructs the driver of the incoming vehicle to direct the incoming vehicle to the parking area. In another embodiment, in the event of the absence of the available space in the queue at the pickup area, the server 102 transmits the eighth message to the driver device 106 of the incoming vehicle for directing the incoming vehicle to the parking area.

In an embodiment, when the first, second, and incoming vehicles are not detected in the zone or in the vicinity of the zone, then at 208, the server 102 transmits the tenth message to the passenger device 104 indicating the cancellation of the booking request. The passenger device 104 receives the tenth message over the first communication network 110. The tenth message can be a pop-up message, an alert message, an SMS, or the like.

After transmitting the first message, at 210, the server 102 checks for the current location of the passenger in the zone. The server 102 may capture the current location of the passenger device 104 based on the GPS information transmitted by the passenger device 104. Based on the current location of the passenger, at 212, the server 102 transmits the second message to the passenger device 104. The second message is transmitted to the passenger device 104, when the current location of the passenger device 104 is not at the pickup area. The second message directs the passenger to the pickup area from the current location of the passenger.

At 214, when the passenger is at the pickup area, the passenger provides the code to the driver of the first vehicle in the queue at the pickup area. At 216, the driver of the first vehicle inputs the code by means of the installed application on the driver device 106 of the first vehicle to transmit the code to the server 102. In another exemplary embodiment, the passenger device 104 may transmit the code to the driver device 106 over the second communication network 112, and the driver device 106 further transmits the code to the server 102 over the first communication network 110 by means of the installed service application.

After receiving the code from the driver device 106 of the first vehicle, at 218, the server 102 validates the received code. The received code is validated by comparing the received code from the driver device 106 of the first vehicle to the code that was transmitted by the server 102 to the passenger device 104 in response to the booking request by the passenger. The received code may be validated to identify the authenticity of the received code or the authenticity of the passenger.

Based on successful validation of the code, the server 102 allocates the first vehicle to the passenger. At 220, the server 102 transmits the third message to the driver device 106 of the first vehicle indicating successful validation of the code and allocation of the first vehicle to the passenger who has provided the code. At 222, the server 102 transmits the fourth message to the driver device 106 of the first vehicle that includes at least the destination location associated with the booking request of the passenger. Further, at 224, the server 102 may transmit the fifth message to the passenger device 104 indicating successful validation of the code and allocation of the first vehicle for the requested ride.

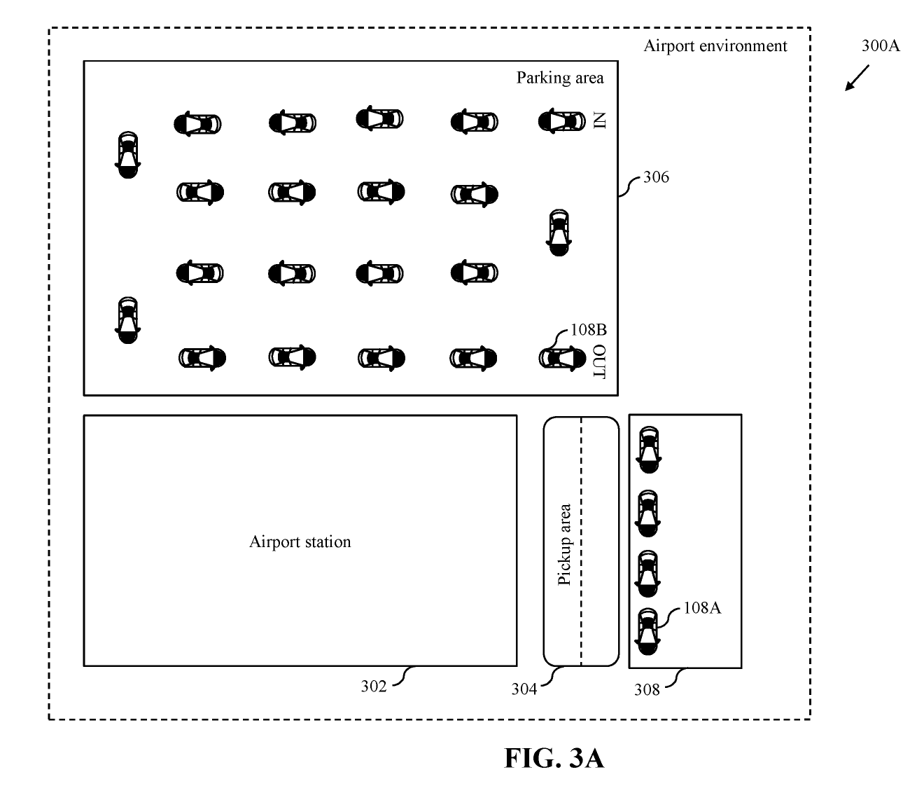

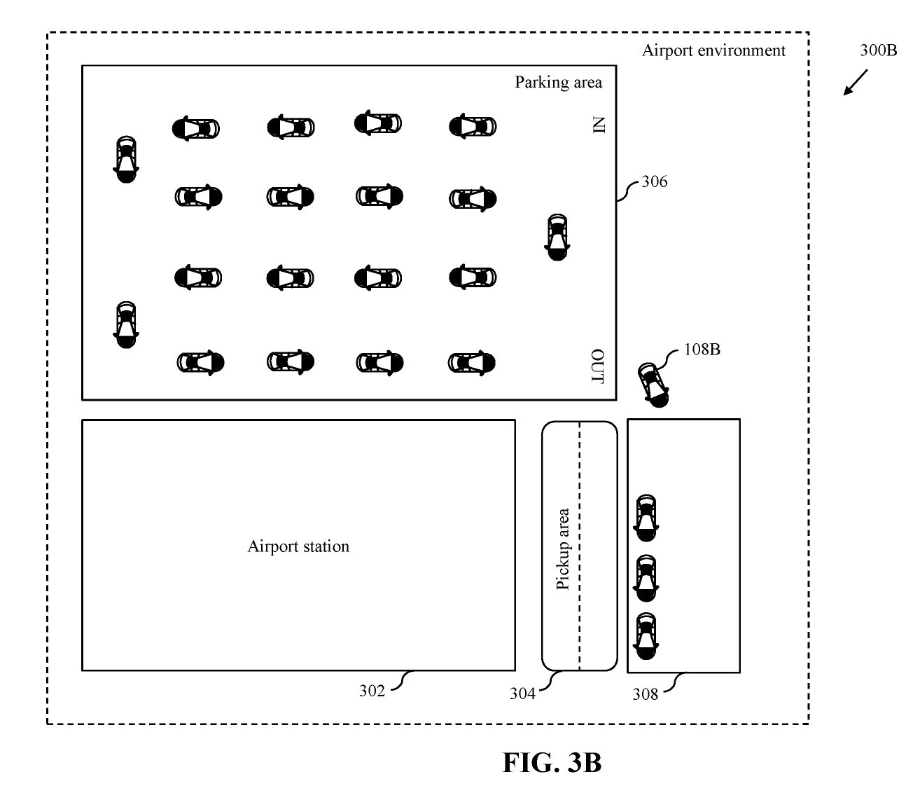

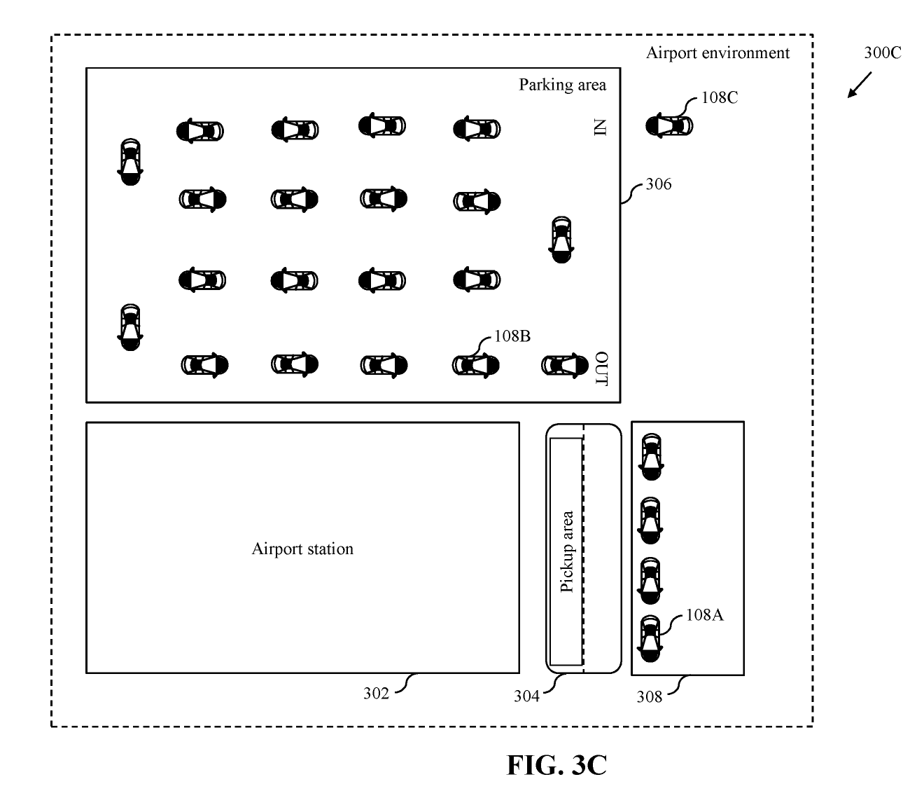

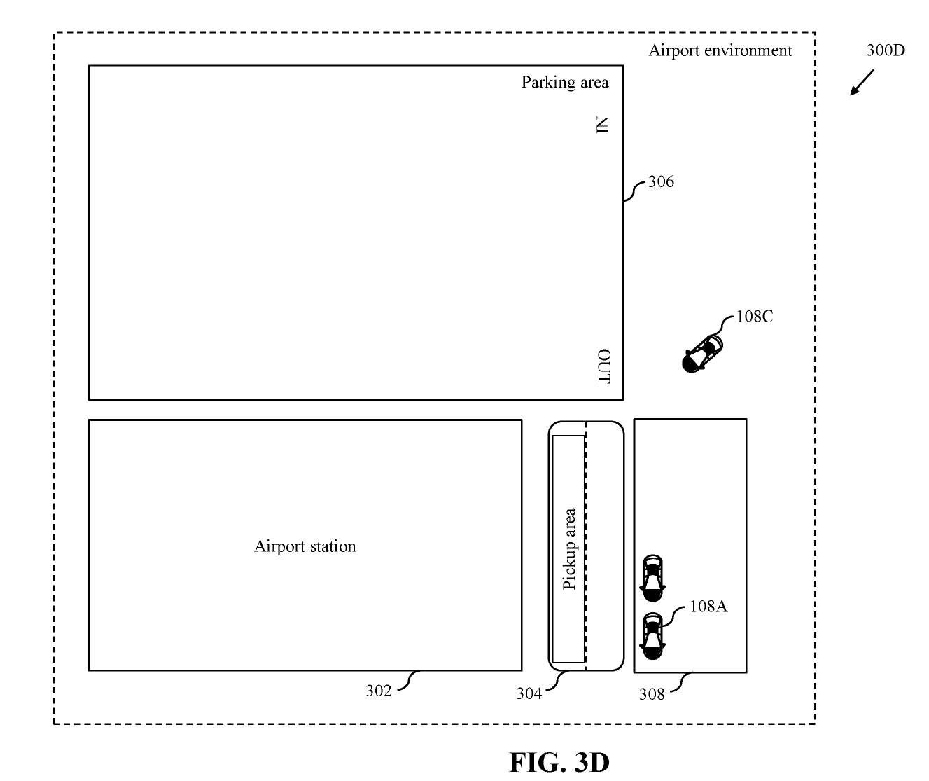

Referring now to FIG. 3A, a block diagram that illustrates an exemplary environment 300A for allocating vehicles to passengers is shown, in accordance with an embodiment of the present invention. The exemplary environment 300A illustrates the zone, such as an airport environment, that includes an airport station 302, the pickup area, such as a pickup area 304, the parking area, such as a parking area 306, and the queue at the pickup area 304, such as a queue 308. The queue 308 includes the first vehicles including the first vehicle 108A. The parking area 306 includes the second vehicles including the second vehicle 108B.

After the passenger has provided the booking request for the ride, the server 102 checks for the availability of the first or second vehicles in the pickup or parking area 304 or 306, respectively. The passenger device 104 receives the first message from the server 102 that indicates the confirmation of the booking request and includes the code for the ride, when the first or second vehicle 108A or 108B, are available in the zone. However, at this point of time, the passenger is not allocated with any vehicle for the ride by the server 102. The passenger device 104 further receives the second message from the server 102 that directs the passenger to the pickup area 304 from the current location of the passenger. The passenger follows the instruction based on the second message to reach the pickup area 304.

In an embodiment, after reaching the pickup area 304, the passenger provides the code to the driver of the first vehicle 108A in the queue 308 of the pickup area 304. The driver of the first vehicle 108A inputs the code into the driver device 106 of the first vehicle 108A, and the driver device 106 transmits the code to the server 102 for validation of the code. In another embodiment, the passenger device 104 transmits the code to the driver device 106 of the first vehicle 108A based on the input provided by the passenger. After successful validation of the code, the server 102 transmits the third message to the driver device 106 of the first vehicle 108A indicating successful validation of the code and allocation of the first vehicle 108A to the passenger. The server 102 further transmits the fourth message to the driver device 106 of the first vehicle 108A that includes at least the destination location of the booking request provided by the passenger. The server 102 may further transmit the fifth message to the passenger device 104 indicating allocation of the first vehicle 108A to the passenger, and may include driver and vehicle information of the driver and the first vehicle 108A. After allocation by the server 102, the passenger may board the first vehicle 108A for the requested ride.

Referring now to FIG. 3B, a block diagram that illustrates an exemplary environment 300B for controlling and managing movement of the second vehicle 108B from the parking area 306 to the queue 308 of the pickup area 304 is shown, in accordance with an embodiment of the present invention. The server 102 monitors the queue 308 at the pickup area 304 to detect the available space in the queue 308 for another vehicle. For example, the available space in the queue 308 may be detected when the driver of the first vehicle 108A had driven the first vehicle 108A from the queue 308 to transport the passenger to the destination location. In the event of detection of the available space in the queue 308, the server 102 transmits the sixth message to the driver device 106 of the second vehicle 108B in the parking area 306 for directing the second vehicle 108B to the available space in the queue 308. Based on the sixth message, the driver of the second vehicle 108B may drive the second vehicle 108B from the parking area 306 to the queue 308.

Referring now to FIG. 3C, a block diagram that illustrates an exemplary environment 300C for controlling and managing the movement of the incoming vehicle in the zone, such as an incoming vehicle 108C, is shown, in accordance with an embodiment of the present invention. The server 102 detects the incoming vehicle 108C in the zone that is available for the new booking request. The server 102 monitors the parking area 306 to detect the available space in the parking area 306. In the event of detection of the available space in the parking area 306, the server 102 transmits the seventh or eighth message to the driver device 106 of the incoming vehicle 108C for directing the incoming vehicle 108C to the available space in the parking area 306. The seventh message may be transmitted to the driver device 106 of the incoming vehicle 108C, when the second vehicles are present in the parking area 306 and the queue 308 has the available space for an additional vehicle. The eighth message is transmitted to the driver device 106 of the incoming vehicle 108C, when the second vehicles are present in the parking area 306 and the queue 308 does not have the available space for an additional vehicle. Based on the seventh or eighth message, the driver of the incoming vehicle 108C may drive the incoming vehicle 108C to the available space in the parking area 306.

Referring now to FIG. 3D, a block diagram that illustrates an exemplary environment 300D for controlling and managing the movement of the incoming vehicle 108C in the zone is shown, in accordance with an embodiment of the present invention. After detecting the incoming vehicle 108C in the zone, if the server 102 determines that the parking area 306 is empty (i.e., no vehicles are available in the parking area 306) and the queue 308 has the available space for another vehicle, then in such a scenario, the server 102 transmits the ninth message to the driver device 106 of the incoming vehicle 108C for directing the incoming vehicle 108C to the available space in the queue 308 of the pickup area 304. Based on the ninth message, the driver of the incoming vehicle 108C may drive the incoming vehicle 108C to the available space in the queue 308.

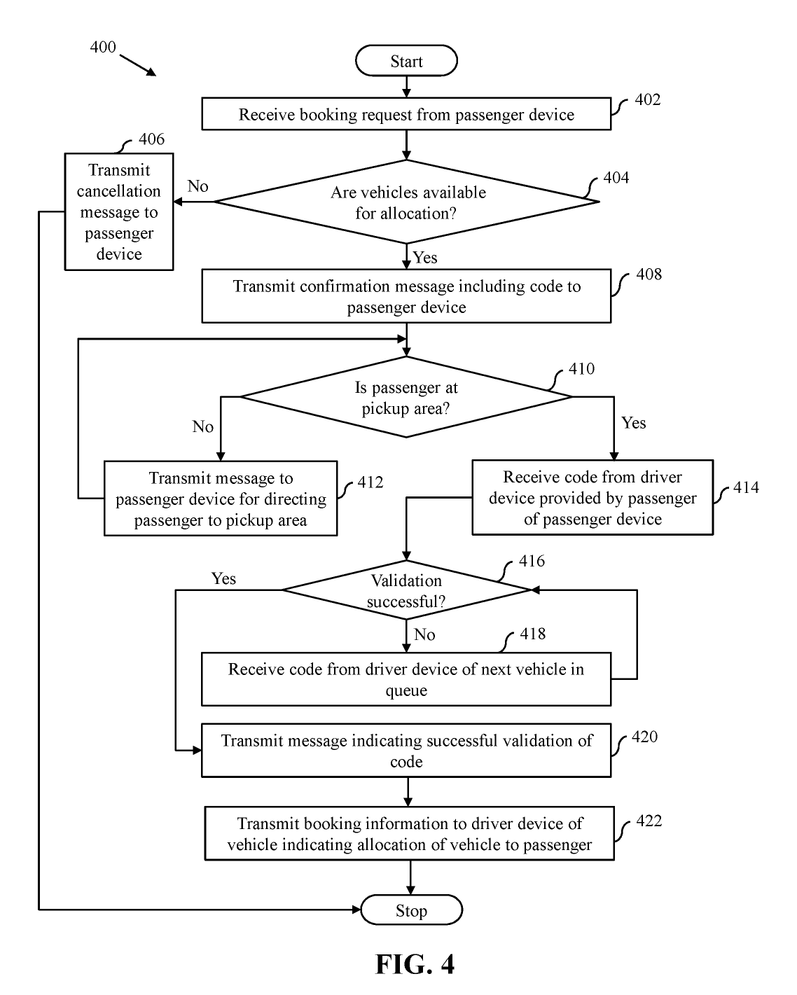

Referring now to FIG. 4, a flow chart 400 that illustrates a method for allocating the vehicles to the passengers is shown, in accordance with an embodiment of the present invention.

At step 402, the server 102 receives the booking request from the passenger device 104 over the first communication network 110. The booking request is the request initiated by the passenger for the ride between the source and destination locations. The source location is associated with the zone, such as the airport, the railway station, the bus station, or the like, that includes at least one of the pickup area 304 or the parking area 306.

At step 404, a check is performed to determine whether any vehicle is available for the ride associated with the received booking request. The server 102 may perform the check to determine the availability of at least one of the first or second vehicles in the queue 308 or the parking area 306, respectively. If at step 404, the server 102 determines that no vehicles are available, either at the queue 308 or the parking area 306, for the received booking request, then step 406 is executed. However, at step 404, if the server 102 determines that at least one of the first or second vehicles are available, then step 408 is executed.

At step 406, the server 102 transmits a cancellation message (i.e., the tenth message) to the passenger device 104 of the passenger over the first communication network 110. The cancellation message indicates the cancellation of the booking request. A person having ordinary skill in the art would understand that the transmission of the cancellation message to the passenger device 104 is not limited to the event where no vehicles are available for the ride requested by the passenger. In an exemplary scenario, at least one of the first or second vehicles may be available at the time of the receipt of the booking request by the server 102. However, the passenger may be at a location (i.e., the current location) away from the pickup area 304. In such a scenario, the first and second vehicles may have been allocated to other passengers before the passenger reaches the pickup location from the current location, and the server 102 may transmit the cancellation message to the passenger device 104.

At step 408, the server 102 transmits a confirmation message (i.e., the first message) to the passenger device 104 over the first communication network 110. The first message is transmitted without allocating any vehicle to the passenger for the ride, and indicates the confirmation of the booking request for the ride. The first message further includes the code for pairing with one of the first vehicles in the queue 308 at the pickup area 304.

At step 410, a check is performed to determine whether the passenger is at the pickup area 304. The server 102 may perform the check based on the GPS information of the passenger device 104 associated with the passenger. Based on the GPS information of the passenger device 104, the server 102 determines the current location of the passenger. If at step 410, the server 102 determines that the current location of the passenger is not the same as the pickup area 304, then step 412 is executed. However, at step 410, if the server 102 determines that the current location of the passenger is the same as the pickup area 304, then step 414 is executed.

At step 412, the server 102 transmits the second message to the passenger device 104 over the first communication network 110. The second message directs the passenger to the pickup area 304 from the current location. Based on the second message, the passenger may follow the instructions (e.g., the voice-based instructions, the graphical-interface based instructions, the text-based instruction, or a combination thereof) to reach the pickup area 304 from the current location.

At step 414, the server 102 receives the code from the driver device 106 of the first vehicle 108A from the first vehicles in the queue 308 at the pickup area 304. After reaching the pickup area 304, the passenger provides the code to the driver of the first vehicle 108A, and the driver inputs the code by means of the installed application on the driver device 106 of the first vehicle 108A. In another embodiment, the passenger device 104 may transmit the code to the driver device 106 of the first vehicle 108A over the second communication network 112. After receiving the code, the driver device 106 of the first vehicle 108A transmits the code to the server 102 over the first communication network 110.

At step 416, a check is performed to determine whether the code has been successfully validated. The server 102 validates the received code. The received code may be validated to identify the authenticity of the received code i.e., whether the received code has been generated by the server 102 or not. The received code may further be validated to identify the authenticity of the passenger of the passenger device 104 to which the server 102 has transmitted the code in response to the received booking request. The received code may further be validated to identify a preference of the driver of the first vehicle 108A to determine whether the driver of the first vehicle 108A is willing to transport the passenger to the destination location of the received booking request. If at step 416, the server 102 invalidates the received code, step 418 is executed. However, at step 416, if the server 102 successfully validates the received code, step 420 is executed.

At step 418, the server 102 receives the code from the driver device 106 of a next vehicle in the queue 308 at the pickup area 304, and step 416 is repeated. The next vehicle may be behind the first vehicle 108A in the queue 308, or in a separate queue next to the queue 308.

At step 420, the server 102 transmits the third message to the driver device 106 of the first vehicle 108A over the first communication network 110. The third message indicates successful validation of the code by the server 102 and allocation of the first vehicle 108A to the passenger. The server 102 may further transmit the fifth message to the passenger device 104 over the first communication network 110. The fifth message may indicate successful validation of the code by the server 102 and allocation of the first vehicle 108A for the ride. The fifth message may further include the driver and vehicle information of the driver of the first vehicle 108A, such as an identity or a rating of the driver, and a vehicle type or a vehicle number of the first vehicle 108A.

At step 422, the server 102 transmits the fourth message to the driver device 106 of the first vehicle 108A over the first communication network 110. The fourth message includes booking information, such the destination location of the booking request or a rating of the passenger. After successful validation of the code and allocation of the first vehicle 108A to the passenger, the passenger may board the first vehicle 108A for the ride, and the driver of the first vehicle 108A may drive out the first vehicle 108A from the queue 308 to transport the passenger to the destination location.

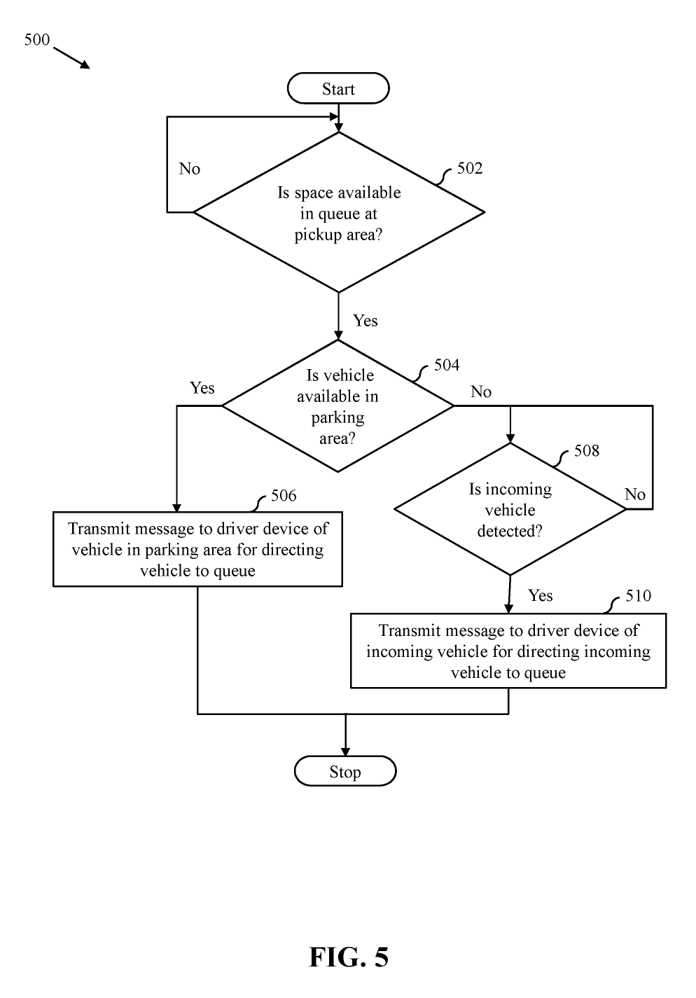

Referring now to FIG. 5, a flow chart 500 that illustrates a method for controlling and managing the availability of the first vehicles in the queue 308 at the pickup area 304 is shown, in accordance with an embodiment of the present invention.

At step 502, a check is performed to determine whether a space is available in the queue 308 at the pickup area 304. In an embodiment, the space in the queue 308 may be available when the driver of the first vehicle 108A allocated to the passenger has driven out the first vehicle 108A from the queue 308 at the pickup area 304 to transport the passenger to the destination location. In another embodiment, the space in the queue 308 may be available when drivers of the first vehicles in the queue 308 have left the queue 308 without any allocation or with allocations having pickup locations outside the zone. If at step 502, the server 102 determines the available space in the queue 308, then step 504 is executed. However, at step 502, if the server 102 determines that the space in the queue 308 is not available, then control goes back to step 502.

At step 504, a check is performed to determine whether the second vehicles are available in the parking area 306. If at step 504, the server 102 determines the availability of the second vehicles in the parking area 306, then step 506 is executed. However, at step 504, if the server 102 determines that the second vehicles are not available in the parking area 306, then step 508 is executed.

At step 506, the server 102 transmits the sixth message to the driver device 106 of the second vehicle 108B from the second vehicles in the parking area 306 over the first communication network 110. The sixth message is transmitted to the driver device 106 of the second vehicle 108B for directing the second vehicle 108B to the queue 308 in the pickup area 304. The second vehicle 108B is selected from the second vehicles in the parking area 306 based on at least one of the sequence of arrival of each second vehicle in the parking area 306 (or the zone), the driver rating of the drivers of the second vehicles, or the vehicle type associated with each second vehicle.

At step 508, a check is performed to determine whether the incoming vehicle 108C has been detected in the zone. If at step 508, the server 102 detects the incoming vehicle 108C that is available for the new booking request, then step 510 is executed. However, at step 508, if the server 102 does not detect the incoming vehicle 108C, then control goes back to step 508.

At step 510, the server 102 transmits the ninth message to the driver device 106 of the incoming vehicle 108C over the first communication network 110. The ninth message is transmitted to the driver device 106 of the incoming vehicle 108C for directing the incoming vehicle 108C to the available space in the queue 308 at the pickup area 304. Based on the ninth message, the driver of the incoming vehicle 108C may drive the incoming vehicle 108C to the available space in the queue 308.

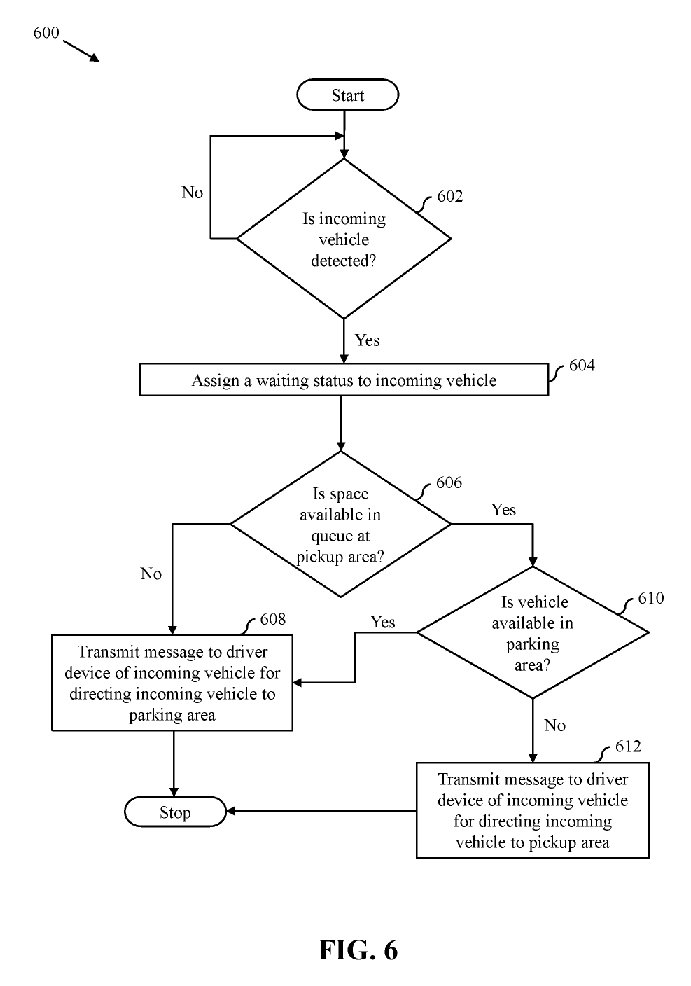

Referring now to FIG. 6, a flow chart 600 that illustrates a method for controlling and managing the movement of the incoming vehicle 108C in the zone is shown, in accordance with an embodiment of the present invention is shown.

At step 602, a check is performed to determine whether the incoming vehicle 108C has been detected in the zone. If at step 602, the server 102 detects the incoming vehicle 108C that is available for the new booking request, then step 604 is executed. However, at step 602, if the server 102 does not detect the incoming vehicle 108C, then control goes back to step 602.

At step 604, the server 102 assigns a waiting status to the incoming vehicle 108C. The waiting status may be assigned to the incoming vehicle 108C to identify the available space in at least one of the queue 308 at the pickup area 304 or the parking area 306 of the zone.

At step 606, a check is performed to determine whether the space is available in the queue 308. If at step 606, the server 102 determines that the space in the queue 308 is not available, then step 608 is executed. However, at step 606, if the server 102 determines the available space in the queue 308, then step 610 is executed.

At the step 608, the server 102 transmits the eighth message to the driver device 106 of the incoming vehicle 108C over the first communication network 110. The eighth message is transmitted to the driver device 106 of the incoming vehicle 108C for directing the incoming vehicle 108C to the parking area 306.

At the step 610, a check is performed to determine whether the second vehicles are available in the parking area 306. If at step 610, the server 102 determines the availability of the second vehicles in the parking area 306, then step 608 is executed. However, at step 610, if the server 102 determines that the second vehicles are not available in the parking area 306, then step 612 is executed.

At step 612, the server 102 transmits the ninth message to the driver device 106 of the incoming vehicle 108C over the first communication network 110. The ninth message is transmitted to the driver device 106 of the incoming vehicle 108C for directing the incoming vehicle 108C to the available space in the queue 308 at the pickup area 304. Based on the ninth message, the driver of the incoming vehicle 108C may drive the incoming vehicle 108C to the available space in the queue 308.

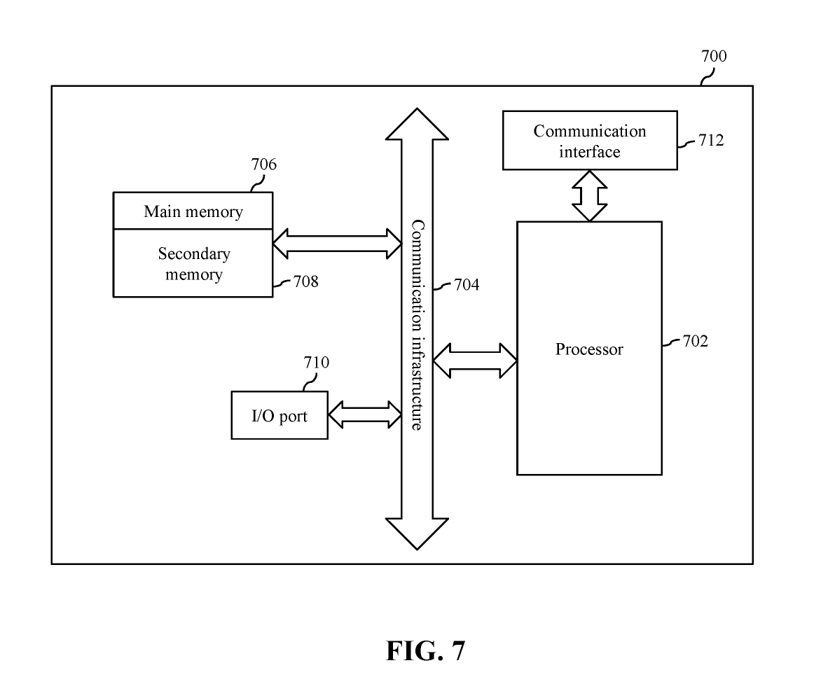

Referring now to FIG. 7, a block diagram that illustrates a computer system 700 for allocating the vehicles to the passengers, and controlling and managing the movement of the vehicles (e.g., the first, second, or incoming vehicle 108A, 108B, or 108C) in the zone is shown, in accordance with an embodiment of the present invention. An embodiment of the present invention, or portions thereof, may be implemented as computer readable code on the computer system 700. In one example, the server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4, 5, and 6.

The computer system 700 includes a processor 702 that may be a special purpose or a general purpose processing device. The processor 702 may be a single processor, multiple processors, or combinations thereof. The processor 702 may have one or more processor “cores.” Further, the processor 702 may be connected to a communication infrastructure 704, such as a bus, a bridge, a message queue, the first communication network 110, the second communication network 112, multi-core message-passing scheme, and the like. The computer system 700 further includes a main memory 706 and a secondary memory 708. Examples of the main memory 706 may include random access memory (RAM), read-only memory (ROM), and the like. The secondary memory 708 may include a hard disk drive or a removable storage drive (not shown), such as a floppy disk drive, a magnetic tape drive, a compact disc, an optical disk drive, a flash memory, and the like. Further, the removable storage drive may read from and/or write to a removable storage device in a manner known in the art. In an embodiment, the removable storage unit may be a non-transitory computer readable recording media.

The computer system 700 further includes an input/output (I/O) port 710 and a communication interface 712. The I/O port 710 includes various input and output devices that are configured to communicate with the processor 702. Examples of the input devices may include a keyboard, a mouse, a joystick, a touchscreen, a microphone, and the like. Examples of the output devices may include a display screen, a speaker, headphones, and the like. The communication interface 712 may be configured to allow data to be transferred between the computer system 700 and various devices that are communicatively coupled to the computer system 700. Examples of the communication interface 712 may include a modem, a network interface, i.e., an Ethernet card, a communications port, and the like. Data transferred via the communication interface 712 may be signals, such as electronic, electromagnetic, optical, or other signals as will be apparent to a person skilled in the art. The signals may travel via a communications channel, such as the first or second communication network 110 or 112 which may be configured to transmit the signals to the various devices that are communicatively coupled to the computer system 700. Examples of the communication channel may include, but are not limited to, cable, fiber optics, a phone line, a cellular phone link, a radio frequency link, a wireless link, and the like.

Computer program medium and computer usable medium may refer to memories, such as the main memory 706 and the secondary memory 708, which may be a semiconductor memory such as dynamic RAMs. These computer program mediums may provide data that enables the computer system 700 to implement the methods illustrated in FIGS. 4, 5, and 6. In an embodiment, the present invention is implemented using a computer implemented application. The computer implemented application may be stored in a computer program product and loaded into the computer system 700 using the removable storage drive or the hard disc drive in the secondary memory 708, the I/O port 710, or the communication interface 712.

A person having ordinary skill in the art will appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor, such as the processor 702, and a memory, such as the main memory 706 and the secondary memory 708, implement the above described embodiments. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present invention provide, among other features, systems and methods for allocating the vehicles to the passengers, and controlling and managing the movement of the vehicles in the zone. Unless stated otherwise, terms such as “first” and “second” are used to arbitrarily distinguish between the elements such terms describe. Thus, these terms are not necessarily intended to indicate temporal or other prioritization of such elements. While various exemplary embodiments of the disclosed system and method have been described above it should be understood that they have been presented for purposes of example only, not limitations. It is not exhaustive and does not limit the invention to the precise form disclosed. Modifications and variations are possible in light of the above teachings or may be acquired from practicing of the invention, without departing from the breadth or scope.

In the claims, the words ‘comprising’, ‘including’ and ‘having’ do not exclude the presence of other elements or steps then those listed in a claim. The terms “a” or “an,” as used herein, are defined as one or more than one. Unless stated otherwise, terms such as “first” and “second” are used to arbitrarily distinguish between the elements such terms describe. Thus, these terms are not necessarily intended to indicate temporal or other prioritization of such elements. The fact that certain measures are recited in mutually different claims does not indicate that a combination of these measures cannot be used to advantage.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

What is claimed is:

1. A vehicle allocation method, the vehicle allocation method comprising:
receiving, by circuitry from a passenger device of a passenger over a communication network, a booking request for booking a ride;
transmitting, by the circuitry to the passenger device over the communication network, a first message based on the booking request without allocating a vehicle to the passenger, wherein the first message indicates a confirmation of the booking request, and wherein the first message includes a code for pairing with one of vehicles in a queue at a pickup area;
receiving, by the circuitry from a driver device associated with one of the vehicles in the queue at the pickup area over the communication network, the code provided by the passenger device or the passenger to the driver device or a driver associated with the driver device, respectively, when the passenger is at the pickup area; and
transmitting, by the circuitry to the driver device over the communication network, a second message indicating successful validation of the code, wherein one of the vehicles that is associated with the driver device that has transmitted the code is allocated to the passenger based on successful validation.

2. The vehicle allocation method of claim 1, further comprising transmitting, by the circuitry to the passenger device over the communication network, a third message for directing the passenger to the pickup area from a current location of the passenger based on the confirmation of the booking request.

3. The vehicle allocation method of claim 1, further comprising transmitting, by the circuitry to the driver device over the communication network, a fourth message including at least destination information associated with the booking request after successful validation of the code.

4. The vehicle allocation method of claim 1, further comprising controlling, by the circuitry, an availability of the vehicles in the queue at the pickup area based on a sequence of arrival of the vehicles.

5. The vehicle allocation method of claim 4, further comprising transmitting, by the circuitry to the driver device associated with an incoming vehicle over the communication network, a fifth message for directing the incoming vehicle to the pickup area in an event of an available space in the queue at the pickup area and in absence of vehicles in a parking area.

6. The vehicle allocation method of claim 4, further comprising transmitting, by the circuitry to the driver device associated with an incoming vehicle over the communication network, a sixth message for directing the incoming vehicle to a parking area in an event of absence of an available space in the queue at the pickup area.

7. The vehicle allocation method of claim 6, further comprising transmitting, by the circuitry to the driver device associated with one of the vehicles in the parking area over the communication network, a seventh message for directing one of the vehicles in the parking area to the pickup area based on at least one of the sequence of arrival of the vehicles in a zone, the available space in the queue at the pickup area, a driver rating of each of drivers associated with the vehicles in the parking area, or a vehicle type associated with each of the vehicles in the parking area.

8. The vehicle allocation method of claim 1, wherein the code corresponds to at least one of a one-time-password (OTP) code, a quick-response (QR) code, or inherence information of the passenger.

9. The vehicle allocation method of claim 1, further comprising transmitting, by the circuitry to the passenger device of the passenger over the communication network, an eighth message indicating a cancellation of the booking request in an event of absence of available vehicles in a zone, wherein the booking request is cancelled based on at least one of a last-in-first-out (LIFO), a passenger value, a booking value, or a distance between the passenger and the pickup area.

10. A vehicle allocation system, the vehicle allocation system comprising:
circuitry configured to:
receive, from a passenger device of a passenger over a communication network, a booking request for booking a ride;
transmit, to the passenger device over the communication network, a first message based on the booking request without allocating a vehicle to the passenger, wherein the first message indicates a confirmation of the booking request, and wherein the first message includes a code for pairing with one of vehicles in a queue at a pickup area;
receive, from a driver device associated with one of the vehicles in the queue at the pickup area over the communication network, the code provided by the passenger device or the passenger to the driver device or a driver associated with the driver device, respectively, when the passenger is at the pickup area; and
transmit, to the driver device over the communication network, a second message indicating successful validation of the code, wherein one of the vehicles that is associated with the driver device that has transmitted the code is allocated to the passenger based on successful validation.

11. The vehicle allocation system of claim 10, wherein the circuitry is further configured to transmit, to the passenger device over the communication network, a third message for directing the passenger to the pickup area from a current location of the passenger based on the confirmation of the booking request.

12. The vehicle allocation system of claim 10, wherein the circuitry is further configured to transmit, to the driver device over the communication network, a fourth message including at least destination information associated with the booking request after successful validation of the code.

13. The vehicle allocation system of claim 10, wherein the circuitry is further configured to control an availability of the vehicles in the queue at the pickup area based on a sequence of arrival of the vehicles.

14. The vehicle allocation system of claim 13, wherein the circuitry is further configured to transmit, to the driver device associated with an incoming vehicle over the communication network, a fifth message for directing the incoming vehicle to the pickup area in an event of an available space in the queue at the pickup area and in absence of vehicles in a parking area.

15. The vehicle allocation system of claim 13, wherein the circuitry is further configured to transmit, to the driver device associated with an incoming vehicle over the communication network, a sixth message for directing the incoming vehicle to a parking area in an event of absence of an available space in the queue at the pickup area.

16. The vehicle allocation system of claim 15, wherein the circuitry is further configured to transmit, to the driver device associated with one of the vehicles in the parking area over the communication network, a seventh message for directing one of the vehicles in the parking area to the pickup area based on at least one of the sequence of arrival of the vehicles in a zone, the available space in the queue at the pickup area, a driver rating of each of drivers associated with the vehicles in the parking area, or a vehicle type associated with each of the vehicles in the parking area.

17. A travel ride booking method, the travel ride booking method comprising:
transmitting, by a passenger device of a passenger to a server over a communication network, a booking request for booking a ride;
receiving, by the passenger device from the server over the communication network, a first message based on the booking request without receiving allocation of a vehicle by the server, wherein the first message indicates a confirmation of the booking request, and wherein the first message includes a code for pairing with one of vehicles in a queue at a pickup area; and
transmitting, by the passenger device over the communication network, the code to a driver device associated with one of the vehicles in the queue at the pickup area, when the passenger is at the pickup area, wherein one of the vehicles including the driver device is allocated to the passenger by the server based on successful validation of the code received from the driver device.

18. The travel ride booking method of claim 17, further comprising receiving, by the passenger device from the server over the communication network, a second message for directing the passenger to the pickup area from a current location of the passenger based on the confirmation of the booking request.

19. The travel ride booking method of claim 17, further comprising receiving, by the passenger device from the server over the communication network, a third message indicating a cancellation of the booking request in an event of absence of available vehicles in a zone, wherein the booking request is cancelled based on at least one of a last-in-first-out (LIFO), a passenger value, a booking value, or a distance between the passenger and the pickup area.
